(19) United States
(12) Patent Application Publication
(10) Pub. No.: US 2007/0271473 A1
(43) Pub. Date: Nov. 22, 2007

(54) Method and system for a semiconductor device with multiple voltage sensors and power control of semiconductor device with multiple voltage sensors

(76) Inventor: Eiichi Hosomi, Austin, TX (US)

Correspondence Address: SPRINKLE IP LAW GROUP, 1301 W. 25TH STREET, SUITE 408, AUSTIN, TX, 78705, US

(21) Appl. No.: 11/436,799

(22) Filed: May 18, 2006

(51) Int. Cl. G06F 1/00

(52) U.S. Cl. 713/300

(57) ABSTRACT

Systems and methods for obtaining a more accurate measurement of the voltage on a die in a semiconductor package are disclosed. These systems and methods may utilize two or more voltage sensors on a die to obtain a set of voltages sensed at multiple locations. These sensed voltages may then be processed to create a representative voltage for the die. This representative voltage may then be used to control the power to the semiconductor device.

### TECHNICAL FIELD OF THE INVENTION

The invention relates in general to methods and systems for semiconductor devices, and more particularly, to semiconductor devices with multiple voltage sensors.

### BACKGROUND OF THE INVENTION

With the advent of the computer age, electronic systems have become a staple of modern life, and some may even deem them a necessity. Part and parcel with this spread of technology comes an ever greater drive for more functionality from these electronic systems. A microcosm of this quest for increased functionality is the size and capacity of various semiconductor devices. From the 8 bit microprocessor of the original Apple I, through the 16 bit processors of the original IBM PC AT, to the current day, the processing power of semiconductors has grown while the size of these semiconductors has consistently been reduce. In fact, Moore's law recites that the number of transistors on a given size piece of silicon will double every 18 months.

As semiconductors have evolved into these complex systems, almost universally the connectivity and power requirements for these semiconductors have been increasing. In fact, the higher the clock frequency utilized with a semiconductor, the greater that semiconductor's power consumption (all other aspects being equal). Part and parcel, however, with the increase in power consumption and operating frequency is the countervailing tendency toward reduced operating voltages in semiconductors and thus, tighter noise budgets. As can be seen then, these requirements may be at odds with one another to a certain extent. In particular, increasing the power consumption of a semiconductor device usually results in more switching noise, which is less than desirable given a tighter noise budget.

In order to ameliorate the dichotomy between these various opposing requirements and desires, actual voltage at a semiconductor device may be tightly controlled. In many cases, a power distribution network regulates power to the semiconductor device based at least in part upon the actual voltage sensed at the semiconductor device. This voltage may be sense using a voltage sensor on the semiconductor device.

The voltage sensed by this voltage sensor, however, is heavily dependent on the placement of the voltage sensor. This dependency is based in no small part on possible voltage gradients on the die area. These voltage gradients may be caused by a DC drop in the package substrate of the semiconductor device or printed circuit board on which the semiconductor device is included, the operation of the semiconductor device, or a myriad number of other causes. A voltage gradient on the semiconductor die naturally means that there will be some difference between the minimum and maximum voltages on the die, and, in most cases, the output from the voltage sensor will only represent the voltage of the area of the die near the voltage sensor. This discrepancy between the voltage measured and the actual voltage on, or across, the semiconductor die may hamper the ability of a power distribution network to regulate power to the semiconductor device.

Thus, a need exists for systems and methods for obtaining a more accurate measurement of the voltage on a semiconductor die.

### SUMMARY OF THE INVENTION

Systems and methods for obtaining a more accurate measurement of the voltage on a die in a semiconductor package are disclosed. These systems and methods may utilize two or more voltage sensors on a die to obtain a set of voltages sensed at multiple locations. These sensed voltages may then be processed to create a representative voltage for the die. This representative voltage may then be used to control the power to the semiconductor device.

In one embodiment, voltages are sensed at multiple locations on a semiconductor die and a signal representative of the voltage on the die is generated from these sensed voltages. This representative voltage signal is then used to control the power provided to the semiconductor die.

In some embodiments, the representative voltage signal may be generated by taking an average of the sensed voltages or a maximum of the sensed voltages.

In other embodiments, the representative voltage signal may be generated by a voltage processing unit. This voltage processing unit may be on the semiconductor die itself, on or in the package of the semiconductor device comprising the die, or external to the semiconductor device.

In yet other embodiments, the representative voltage signal may be provided at one or more voltage sense pins of the semiconductor device.

In another embodiment, signals representative of voltages sensed on the semiconductor die may be provided at one or more voltage sense pins on the semiconductor device.

Embodiments of the present invention may allow the power delivered to a semiconductor die to be more accurately regulated by providing a more accurate measurement of the voltage or voltages on a semiconductor die. These more accurate measurements may allow for power regulation methodologies that take into account voltage gradients or differentials across, or on, a semiconductor device and therefore better control the delivery of power based on these measured voltage.

Additionally, embodiments of the present invention offer the advantage that when used with certain multi-core processors they allow the voltage in each one of the cores to be measured and a representative voltage for the die generated from voltages measured at each of the cores. Thus, a more accurate representative voltage can be generated and power to the die better regulated.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a block diagram of one embodiment of portions of a power distribution network for providing power to a semiconductor device.

FIG. 2A depicts a cutaway diagram of one embodiment of a semiconductor package coupled to a printed circuit board.

FIGS. 2B and 2C depict two examples of voltage gradients which may exits across semiconductor dies during operation of those dies.

FIG. 3 depicts a block diagram of one embodiment of portions of a power distribution network for providing power to a semiconductor device with multiple voltage sensors.

FIG. 4 depicts a block diagram of one embodiment of a semiconductor device with multiple voltage sensors.

FIG. 5 depicts a block diagram of one embodiment of portions of a power distribution network for providing power to a semiconductor device with multiple voltage sensors.

FIG. 6 depicts a block diagram of one embodiment of a semiconductor device with multiple voltage sensors.

FIG. 7 depicts a block diagram of one embodiment of a semiconductor device with multiple voltage sensors.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

Reference is now made in detail to the exemplary embodiments of the invention, examples of which are illustrated in the accompanying drawings. Wherever possible, the same reference numbers will be used throughout the drawings to refer to the same or like parts (elements).

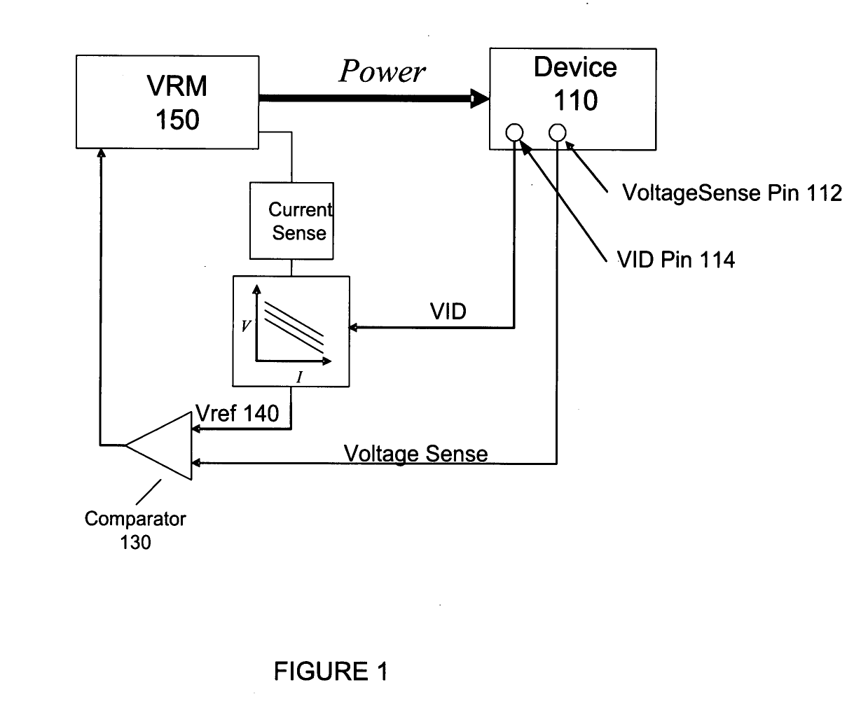

Before describing embodiments of the present invention it may be useful to describe an exemplary architecture for a power distribution network which is operable to control the power to a semiconductor device. FIG. 1 depicts a block diagram of a portion of one example of just such a power distribution network. Semiconductor device 110 may comprise a semiconductor die (not shown) and a substrate or package. The die may be an integrated circuit, such as a microprocessor, coupled to a package which may serve to couple the die to a power source or other signal lines. Typically, the substrate with which microprocessors or semiconductors are packaged is made of organic material (such as epoxy resin) and may be fabricated using build-up technology.

Semiconductor device 110 may comprise two outputs: a voltage identification (VID) output 114 and a voltage (Vdd) sensed output 112. Each of these outputs may be one or more pins on the package of semiconductor device 110; the VID output 114 operable to provide one or more setting which define the voltage required by the die of semiconductor device 110 and the Vdd output 112 operable to provide a signal representing a voltage sensed on the die of device 110 by a voltage sensor.

Vdd sense pin 112 may be coupled to an input of comparator 130, which also receives as input voltage reference signal 140. Comparator 130 provides an output representing the difference between the signal received from Vdd sense pin 112 and the voltage reference signal 140. Voltage regulator module (VRM) 150 receives this differential signal as an input and is operable to regulate the power provided to device 110 based on this differential signal.

More particularly, in one embodiment, during operation of the portion of the power distribution network depicted in FIG. 1 the power to device 110 may be regulated using a technique called droop control. Thus, it is desired that output voltage from VRM 150 is decreased as output current from VRM 150 is increased. To implement this type of power control, in one embodiment the slope of the current-voltage (I-V) curve utilized by the power distribution network may be the same for different VID settings, but the intercept utilized in conjunction with the I-V curve depends on the VID setting.

Consequently, during operation of the power distribution network the VID setting may be used in conjunction with the sensed current output of VRM 150 to determine an appropriate reference voltage and this reference voltage is provided to comparator 130. Comparator 130 compares this references voltage on input 140 to the sensed voltage signal on the input coupled to Vdd sense pin 112 and provides a signal representing the difference between these two inputs to VRM 150, which, in turn, regulates the power to device 110 based on this differential signal.

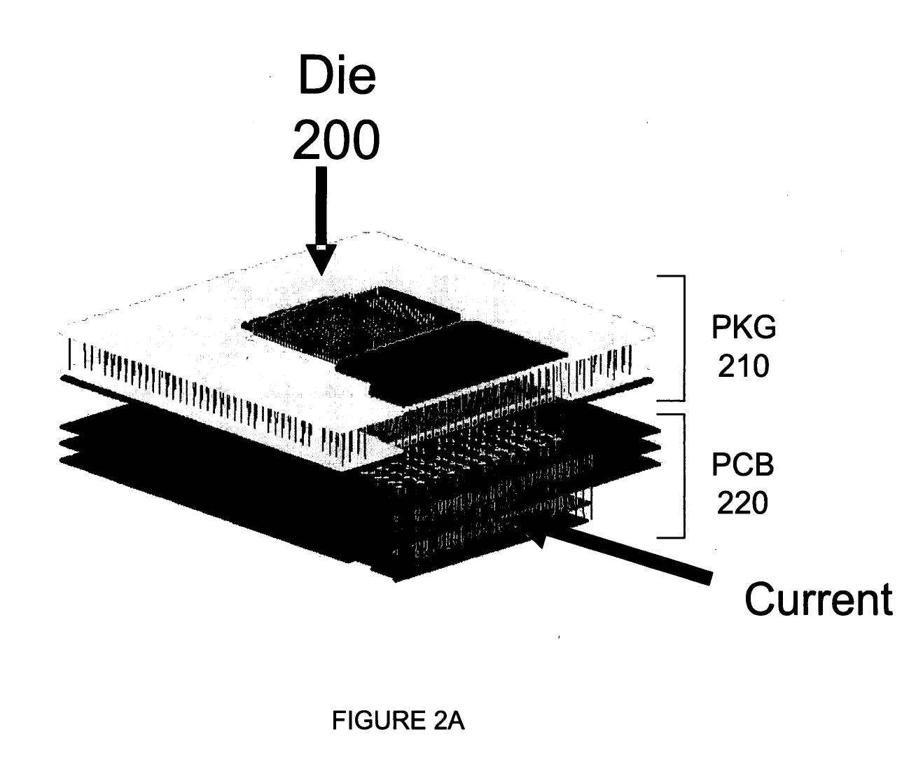

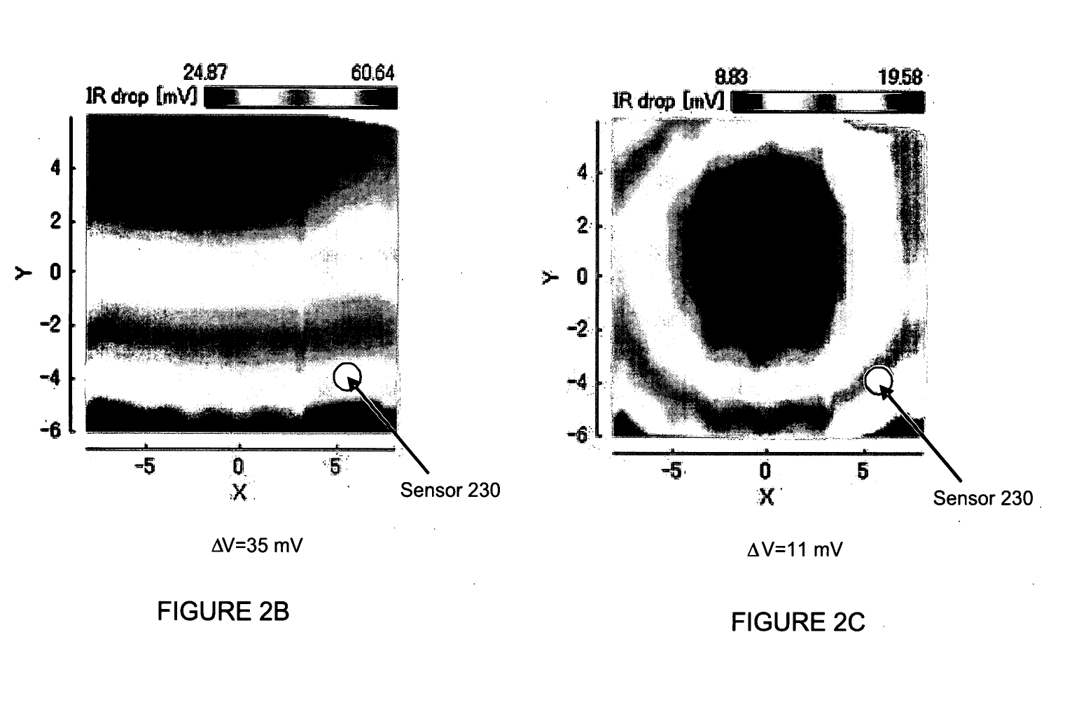

Typically, however, the die of device 110 has only one voltage sensor. This arrangement may be problematic as may be better explained with reference to FIGS. 2A, 2B and 2C. FIG. 2A depicts one embodiment of semiconductor device 110 comprising die 200 and package 210. In many instances, when semiconductor device 110 is utilized in an operational capacity it is coupled to printed circuit board (PCB) 220. Current can then be provided from a power supply such as VRM 150 to die 200 via PCB 220 and package 210.

Due to a variety of circumstances, including DC drop in the package substrate of package 210 of device 110 and PCB 220 to which device 110 is usually coupled, a voltage gradient may be extant on die 200 of device 110 during operation of semiconductor device 110. It will be apparent that the voltage distribution across die 200 will depend on the design and construction of die 200 itself, package 210 with which die 200 is utilized and the configuration, design or construction of PCB 220, among myriad other variables. As a result of the voltage gradient on die 200 there may be a marked difference between the maximum or minimum voltage on die 200 and the voltage in the vicinity of a single voltage sensor present on die 200. Consequently, the voltage sensed at a voltage sensor, and thus the signal output at Vdd sense pin 112 may not accurately reflect the voltage across die 200, and may vary markedly based on the placement of the voltage sensor on die 200 (all other factors being equivalent).

FIG. 2B depicts a representation of the voltages in various parts of die 200 which may occur during one mode of operation of device 110. Notice that in FIG. 2B the voltage gradient across die 200 may be approximately 35 mV. Voltage sensor 230 may be placed in an area of die 200 where the voltage during this mode of operation is approximately 25 mV. The signal output on Vdd sense pin 112 may therefore reflect that the voltage on die 110 is approximately 25 mV. As can be seen from FIG. 2B, however, voltage in other areas of die 200 may be approximately 60 mV. Thus, the output of Vdd sense pin 112 does not accurately represent the voltage across the entire die 110.

This problem can be further illustrated with respect to FIG. 2C. FIG. 2C depicts a representation of the voltages in various parts of die 200 which may occur during another mode of operation of device 110. Notice that in FIG. 2C the voltage gradient across die 200 may be approximately 11 mV. Voltage sensor 230 may be placed in an area of die 200 where the voltage during this mode of operation is approximately 10 mV. The signal output on Vdd sense pin 112 may therefore represent that the voltage on die 110 is approximately 10 mV. As can be seen from FIG. 2C, however, voltage in other areas of die 200 may be approximately 19.5 mV. Thus, the output of Vdd sense pin 112 does not accurately represent the voltage across the entire die 110.

The discrepancy between the voltage sensed and the actual voltages occurring in different parts of die 110 can adversely affect the ability of a power control network to modulate or control power to a semiconductor device. Therefore, it is desired to provide a more accurate measurement of voltage across die 200 such that power to device 110 may be better controlled.

Attention is now directed to systems and methods for obtaining a more accurate measurement of the voltage on a die. These systems and methods may utilize two or more voltage sensors on a die to obtain a set of voltages sensed at multiple locations. These sensed voltages may then be processed to create a representative voltage for the die. This representative voltage may then be used to control the power to the semiconductor device comprised by the die.

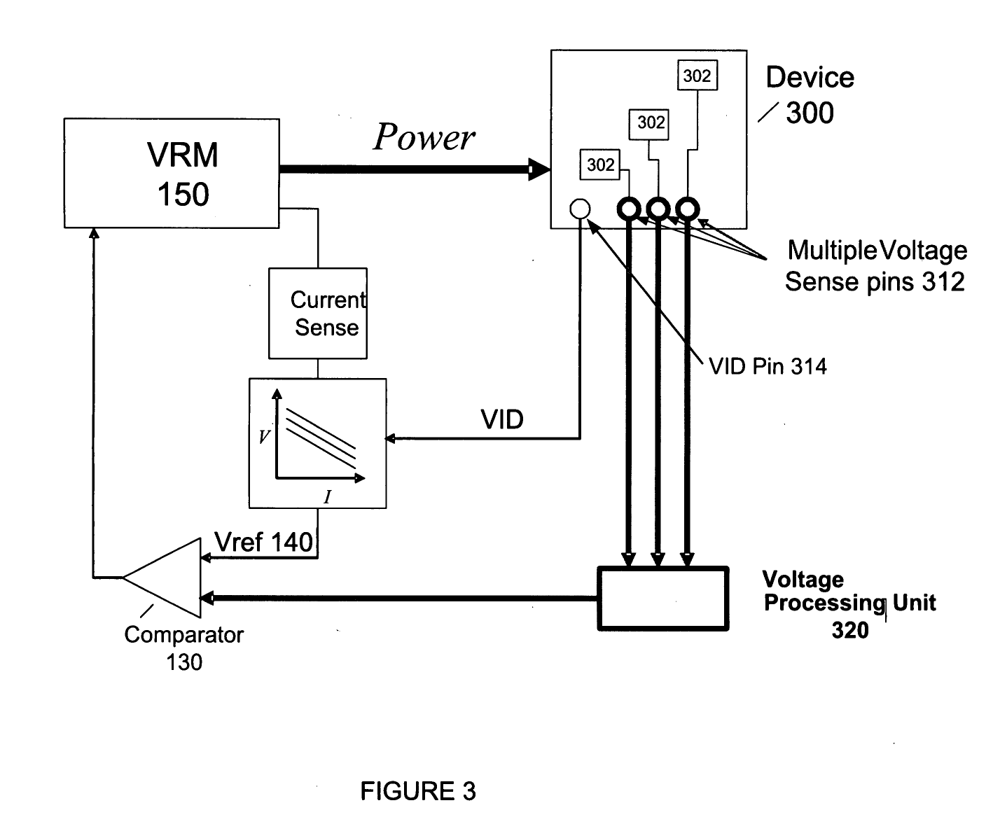

FIG. 3 depicts one embodiment of portions of a power distribution network which may be utilized in conjunction with one embodiment of a semiconductor device with multiple voltage sensors. More specifically, semiconductor device 300 may comprise a semiconductor die (not shown) and a substrate or package. Semiconductor device 300 may have a plurality of voltage sensors 302, each voltage sensor 302 operable to sense a voltage at a different location on the die of semiconductor device 300.

Semiconductor device 300 may comprise a set of output pins. In particular, semiconductor device 300 may have a voltage identification (VID) output pin 314 and a set of Voltage (Vdd) sense pins 312. The VID pin 314 is operable to provide one or more settings which define the voltage required or desired by the die of semiconductor device 300, while each of the Vdd sense pins 312 may be coupled to a voltage sensor 302 and operable to provide a signal representative of the voltage sensed by that voltage sensor 302.

Each of Vdd sense pins 312 may be coupled to an input of voltage processing unit (VPU) 320. In one particular embodiment, each Vdd sense pin 312 may be coupled to VPU 320 using two signal lines, where the difference in voltage between the two signal lines is approximately equal to the voltage sensed at voltage sensor 302 to which that Vdd sense pin 312 is coupled.

VPU 320 is operable receive two or more signals representing sensed voltages at its inputs and create a representative voltage signal from these sensed voltage signals. This representative voltage signal may be created by averaging the signals representing the sensed voltages, taking the maximum of the signals representing the sensed voltages, or by another desired method.

The representative voltage signal from VPU 320 is provided to an input of comparator 130, which also receives as input voltage reference signal 140. Comparator 130 provides an output representing the difference between the representative voltage signal received from VPU 320 and voltage reference signal 140. Voltage regulator module (VRM) 150 receives this differential signal as an input and is operable to regulate the power provided to device 300 based on this differential signal.

More particularly, in one embodiment, it may be desirable to operate the power distribution network depicted in FIG. 3 using a technique called droop control, as discussed above. Consequently, during operation of the power distribution network the VID setting from VID pin 314 may be used in conjunction with a sensed current output of VRM 150 to determine an appropriate reference voltage. This reference voltage is provided to comparator 130. Comparator 130 compares this reference voltage to the representative voltage signal created by VPU 320 from each of the sensed voltages signals received from Vdd sense pins 312 and provides a signal indicating the difference between these two inputs to VRM 150, which, in turn, regulates the power to device 300 based on this differential signal.

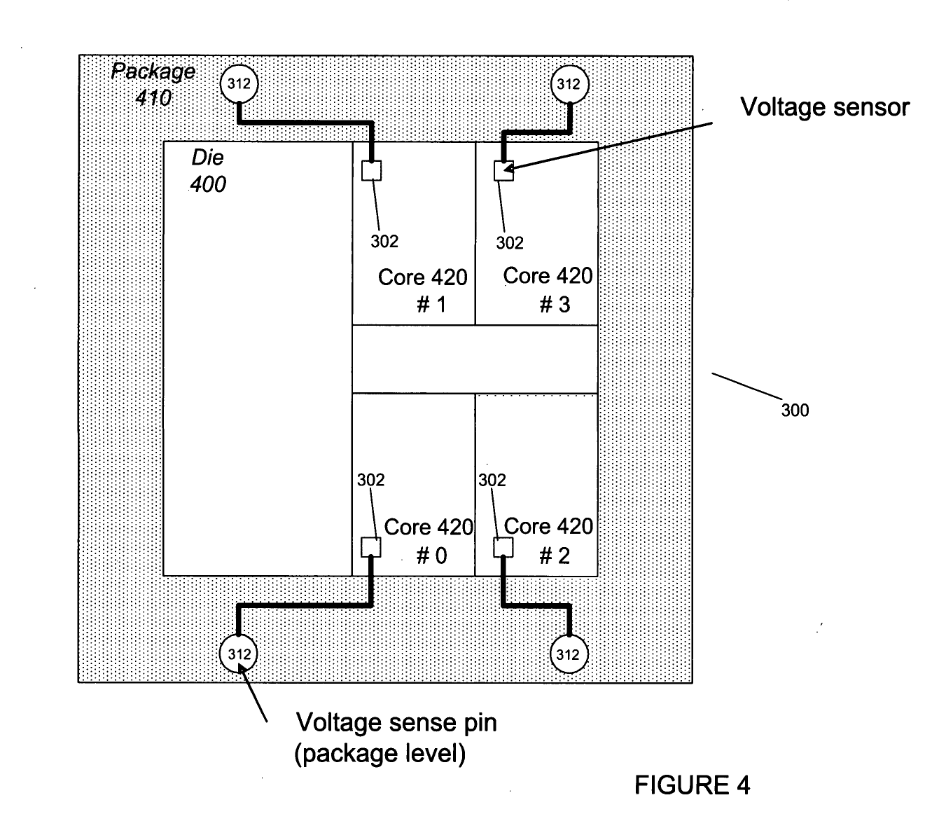

Turning now to FIG. 4, a schematic view of one embodiment of a die and package layout which may utilized to implement device 300 is depicted. Semiconductor device 300 comprises die 400 coupled to package 410. Die 400 may, in turn, comprise a set of processor cores 420. Each of processor cores 420 comprises a voltage sensor 302, where each of voltage sensors 302 may be coupled to a unique Vdd sense pin 312 on package 410. This may be accomplished by coupling voltage sensor 302 to its respective Vdd sense pin 312, in some embodiments by coupling voltage sensor 302 to an output pin of die 410 and coupling that output pin of die 410 to the respective Vdd sense pin 312.

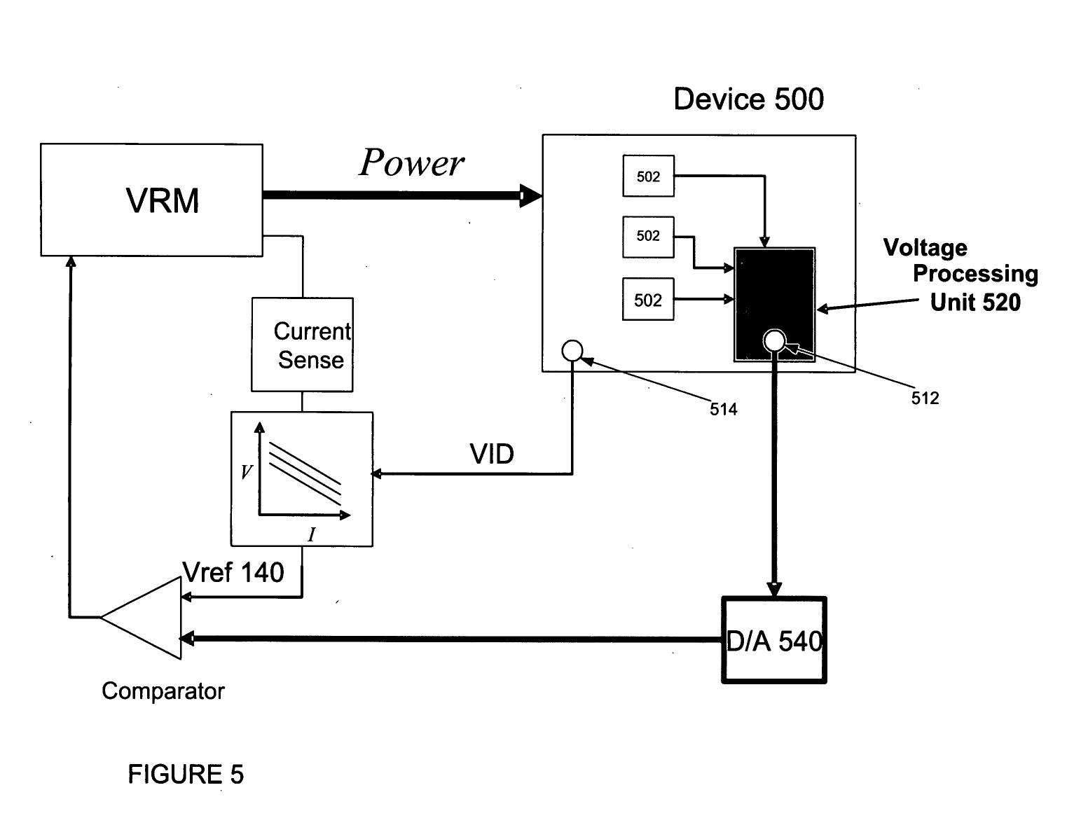

Moving on, FIG. 5 depicts another embodiment of portions of a power distribution network which may be utilized in conjunction with one embodiment of a semiconductor device with multiple voltage sensors. More specifically, semiconductor device 500 may comprise a semiconductor die (not shown) and a substrate or package. Semiconductor device 500 may comprise VPU 520 and a plurality of voltage sensors 502, each voltage sensor 502 operable to sense a voltage at a different location on the die of semiconductor device 500 and provide a signal representative of the sensed voltage to VPU 520.

VPU 520, which may be formed on the die of semiconductor device 500, is operable receive signals representative of the sensed voltages from voltage sensors 502 and create a representative voltage signal from these sensed voltage signals. In one embodiment, voltage sensors 502 may generate an analog signal representative of the sensed voltage. This analog signal may be processed by VPU 520 and a digital representative voltage signal generated by VPU 520. More specifically, this may be accomplished by converting each of the received analog signals representative of sensed voltages to a corresponding digital signal at VPU 520 before processing. Alternatively, voltage sensor 502 may itself include a Analog-to-Digital (A/D) converter, and thus the analog signal representative of the sensed voltage may be converted to a digital signal and this digital signal representative of the sensed voltage provided to VPU 520.

VPU 520 may be coupled to Vdd sense pin 512 of device 500 such that the representative voltage signal produced by VPU 520 may be available at Vdd sense pin 512. Additionally, semiconductor device 500 may also have voltage identification (VID) output pin 514 operable to provide one or more settings which define the voltage required or desired by the die of semiconductor device 500.

In some cases, as the representative voltage signal provided at Vdd sense pin 512 is a digital signal, Vdd sense pin 512 may, in turn, be coupled to an input of Digital-to-Analog (D/A) converter 540 operable to convert the input digital representative voltage signal to an analog representative voltage signal. This analog representative voltage is provided to an input of comparator 130, which also receives as input voltage reference signal 140. Comparator 130 provides an output signal representing the difference between the analog representative voltage signal received from D/A converter 540 and voltage reference signal 140. Voltage regulator module (VRM) 150 receives this differential signal as an input and is operable to regulate the power provided to device 500 based on this differential signal.

More particularly, in one embodiment, it may be desirable to operate the power distribution network depicted in FIG. 5 using a technique called droop control, as discussed above. Consequently, during operation of the portions of the power distribution network depicted, the VID setting from VID pin 514 may be used in conjunction with a sensed current output of VRM 150 to determine an appropriate reference voltage. This reference voltage is provided to comparator 130. Comparator 130 compares this reference voltage to the analog representative voltage signal provided by D/A converter 540 and provides a signal representative of the difference between these two inputs to VRM 150, which, in turn, regulates the power to device 110 based on this differential signal.

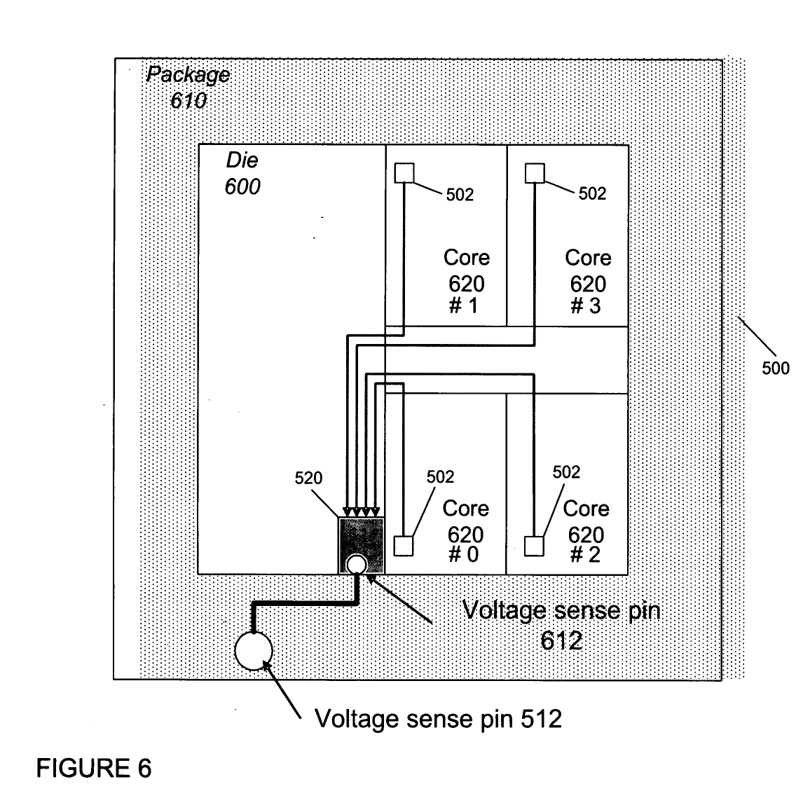

Turning now to FIG. 6, a schematic view of one embodiment of a die and package layout which may utilized to implement device 500 of FIG. 5 is depicted. Semiconductor device 500 comprises die 600 coupled to package 610. Die 600 may, in turn, comprise a set of processor cores 620 and VPU 520. Each of processor cores 620 comprises voltage sensor 502, where each of voltage sensors 502 may be coupled to VPU 520 on die 510. VPU 520, is, in turn, coupled to Vdd sense pin 512. This may be accomplished by coupling VPU 520 to a die level voltage level sense pin 612 and coupling this die level voltage sense pin 612 to Vdd sense pin 512 such that VPU 520 may provide a representative voltage signal to Vdd sense pin 512 though die level voltage sense pin 612. It can be seen then, that by placing VPU 520 on die 610 itself, a representative voltage signal can be provided external to package 610 using, if desired, a single pin on die 600 and a single pin on package 610.

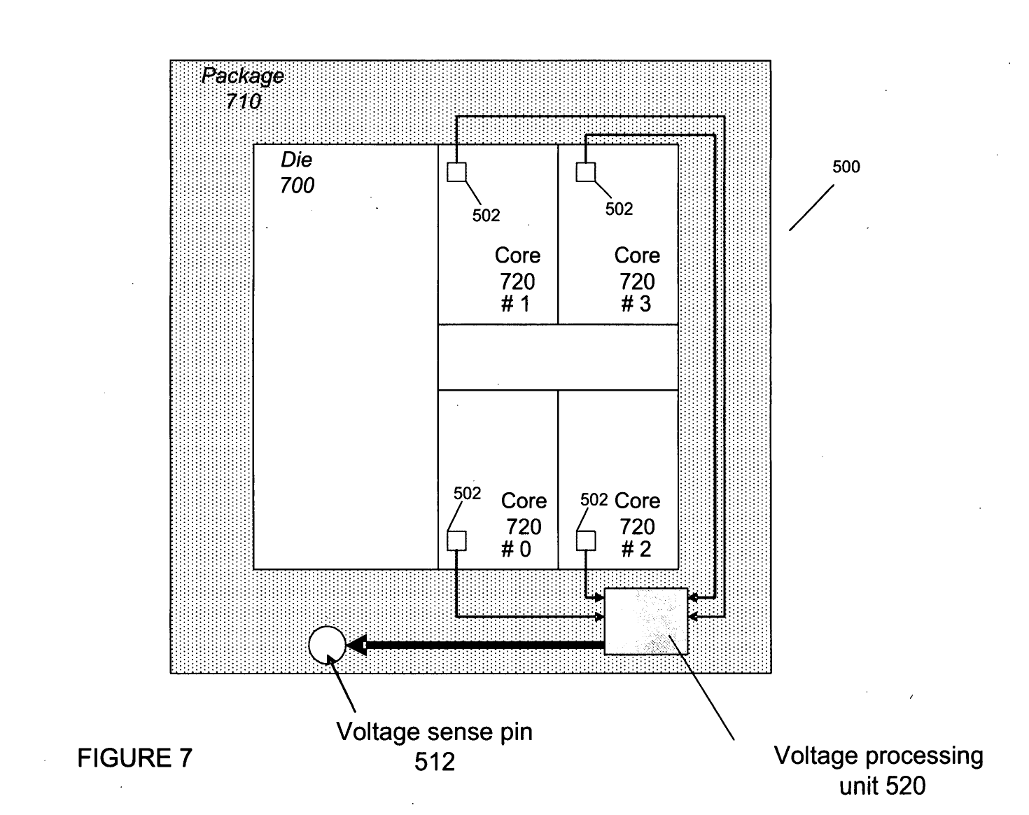

Turning now to FIG. 7, a schematic view of another embodiment of a die and package layout which may utilized to implement device 500 of FIG. 5 is depicted. Semiconductor device 500 comprises die 700 coupled to package 710. Die 700 may, in turn, comprise a set of processor cores 720. Package 710 may comprise VPU 520. In one embodiment, VPU 520 may be a die distinct from die 700 and may be coupled to package 710.

Each of processor cores 720 comprises voltage sensor 502, where each of voltage sensors 502 may be coupled to VPU 520 in package 710. VPU 520, is, in turn, coupled to Vdd sense pin 512. This may be accomplished by coupling each of voltage sensors 502 to VPU 520 using die level pins and coupling an output of VPU 520 to Vdd sense pin 512 such that VPU 520 may provide a representative voltage signal at Vdd sense pin 512. It can be seen then, that by utilizing a distinct die for VPU 520 and locating VPU 520 in package 710, a representative voltage signal can be provided using a single pin on package 710 without the need to form VPU 520 on die 710.

It will be apparent that though embodiments of the invention depicted are pictured having four processor cores embodiments of the invention may apply equally well to a lesser or greater number of processor cores on a die. Additionally, it will be apparent that though each processor core may be pictured as having one voltage sensor each processor core may contain two or more voltage sensors 302 as desired.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method, comprising:
sensing a voltage at each of a plurality of locations on a semiconductor die; and
controlling power to the semiconductor die based on the voltage sensed at each of the plurality of locations.

2. The method of claim 1, further comprising providing a signal representative of a voltage on the semiconductor die based on the voltages sensed at the plurality of locations.

3. The method of claim 2, further comprising generating a plurality of signals, wherein each of the signals is representative of the voltage sensed at a location.

4. The method of claim 3, further comprising processing the plurality of signals.

5. The method of claim 4, wherein processing the plurality of signals comprises converting each of the plurality of signals from analog to digital.

6. The method of claim 4, wherein processing the plurality of signals comprises averaging the voltages sensed at the plurality of the locations.

7. The method of claim 4, wherein processing the plurality of signals comprises finding a maximum of the voltages sensed at the plurality of locations.

8. The method of claim 4, wherein each of the plurality of locations comprises a processor core.

9. The method of claim 4, further comprising generating a difference signal.

10. The method of claim 9, wherein generating a difference signal comprises comparing the representative signal with a reference signal.

11. The method of claim 10, further comprising generating a reference signal.

12. The method of claim 11, wherein the reference signal is generated based on a voltage identification (VID) signal.

13. The method of claim 12, wherein the reference signal is generated based on a sensed current.

14. The method of claim 10, wherein generating a difference signal further comprises converting the representative signal from digital to analog.

15. The method of claim 10, wherein controlling power provided to the semiconductor die is based on the difference signal.

16. A system, comprising:
a semiconductor device, comprising:
a semiconductor die, the semiconductor die comprising a plurality of voltage sensors.

17. The system of claim 16, wherein the semiconductor device further comprises a package, the package comprising a plurality of voltage output pins, each of the plurality of voltage output pins coupled to one of the plurality of voltage sensors.

18. The system of claim 17, wherein the semiconductor die comprises a plurality of processor cores, wherein each of the plurality of processor cores comprises one or more of the plurality of voltage sensors.

19. The system of claim 17, further comprising a voltage processing unit coupled to the voltage output pins and operable to provide a representative voltage signal.

20. The system of claim 19, further comprising a comparator operable to receive a reference signal and the representative voltage signal and provide a difference signal.

21. The system of claim 19, further comprising a voltage regulation module operable to control power to the semiconductor die based on the difference signal.

22. The system of claim 16, further comprising a package wherein the package comprises a voltage output pin operable to provide a representative voltage signal, the voltage output pin coupled to a voltage processing unit, wherein the semiconductor die further comprises the voltage processing unit and the voltage processing unit is coupled to each of the plurality of voltage sensors.

23. The system of claim 22, wherein the voltage processing unit comprises an analog to digital converter.

24. The system of claim 22, wherein the semiconductor die comprises a plurality of processor cores, wherein each of the plurality of processor cores comprises one or more of the plurality of voltage sensors.

25. The system of claim 22, wherein the die comprises a voltage output pin, wherein the voltage output pin of the die is coupled to the voltage processing unit and the voltage output pin of the package.

26. The system of claim 25, further comprising a comparator operable to receive a reference signal and the representative voltage signal and provide a difference signal.

27. The system of claim 26, further comprising a digital to analog converter operable to receive the representative voltage signal in digital form, convert the representative voltage signal to analog form and provide the representative voltage signal to the comparator.

28. The system of claim 26, further comprising a voltage regulation module operable to control power to the semiconductor die based on the difference signal.

29. The system of claim 16, further comprising a package, wherein the package comprises a voltage output pin operable to provide a representative voltage signal and a voltage processing unit coupled to each of the plurality of voltage sensors and the voltage output pin.

30. The system of claim 29, wherein the voltage processing unit comprises an analog to digital converter.

31. The system of claim 29, wherein the semiconductor die comprises a plurality of processor cores, wherein each of the plurality of processor cores comprises a voltage sensor.

32. The system of claim 29, wherein the semiconductor die comprises a plurality of voltage output pins, each of the voltage output pins of the die coupled to a voltage sensor and the voltage processing unit.

33. The system of claim 32, further comprising a comparator operable to receive a reference signal and the representative voltage signal and provide a difference signal.

34. The system of claim 33, further comprising a digital to analog converter operable to receive the representative voltage signal in digital form, convert the representative voltage signal to analog form and provide the representative voltage signal to the comparator.

35. The system of claim 33, further comprising a voltage regulation module operable to control power to the semiconductor die based on the difference signal.
